(19) United States
(12) Patent Application Publication
(10) Pub. No.: US 2005/0237593 A1
(43) Pub. Date: Oct. 27, 2005

(54) PMD system and method for operating same

(76) Inventors: Zhanping Xu, Netphen (DE); Jochen Frey, Wetzlar (DE); Tobias Moller, Grossenluder (DE); Holger Kraft, Siegen (DE); Helmut Riedel, Oberhausen (DE)

Correspondence Address: John F. McNulty;Paul & Paul, 2900 Two Thousand Market Street, Philadelphia, PA, 19103, US

(21) Appl. No.: 11/098,326

(22) Filed: Apr. 4, 2005

(30) Foreign Application Priority Data
Apr. 5, 2004 (DE) 10 2004 016 625.0

(51) Int. Cl. H04B 10/12

(52) U.S. Cl. 359/264

(57) ABSTRACT

The present invention relates to an electromagnetic mixing system for receiving and processing modulated electromagnetic signals, with a signal detector made from a semiconductor material for receiving and converting electromagnetic radiation into an electric measured value and with at least one modulation input modulating the reception of the signal detector, and also with at least two accumulation electrodes which are connected to output electronics at the output of which a mixture of the received signal and at least one modulation signal applied at the modulation input is effectively provided as electric signal. The present invention also relates to a method for operating such an electromagnetic mixing system, the electromagnetic signals striking the signal detector producing charge carriers which, depending on the at least one modulation signal, are conducted at least partially alternately to the at least two different readout electrodes. In order to create a system and a method which also delivers correct mixer results in the case of geometric or electric asymmetries of the PMD elements, i.e. measurement signals based exclusively on the coherent radiation, it is proposed according to the invention that apparatuses for modifying parameters of the at least one modulation signal are provided such that by modifying these parameters the output signal is different from a zero signal only if the modulations of the received electromagnetic radiation signal and the at least one modulation signal are correlated with each other. As regards the method, it is proposed that the signals derived from the accumulation electrodes and entered [by] the output electronics are varied such that the output signal assumes a value different from the zero signal only if the at least one modulation signal and the modulated electromagnetic reception signal are correlated with each other.

The present invention relates to an electromagnetic mixing system for receiving and processing modulated electromagnetic signals, with a signal detector made from a semiconductor material for receiving and converting electromagnetic radiation into an electric measured value and with at least one modulation input modulating the reception of the signal detector, and also with at least two accumulation electrodes which are connected to output electronics at the output of which a mixture of the received signal and at least one modulation signal applied to the modulation input is effectively provided as electric signal.

The present invention also relates to a method for operating such an electromagnetic mixing system for receiving and processing modulated electromagnetic signals, with a signal detector made from a semiconductor material for receiving and converting electromagnetic radiation into an electromagnetic measured value, and with at least one modulation input modulating the reception of the signal detector, and also at least two accumulation electrodes which are connected to output electronics at the output of which a mixture of the received signal and at least one modulation signal applied to the modulation input is effectively provided as electric signal, the electromagnetic signals striking the signal detector producing charge carriers which, according to the at least one modulation signal, are at least partially conducted alternately to the two different accumulation electrodes.

Corresponding electronic mixing systems were described for the first time in the German patent applications nos. 196 35 932.5 and 197 04 496.4.

Further electromagnetic mixing systems of the type mentioned above and also corresponding methods for describing them are known from the international patent applications: WO-0233817 and WO-0233922.

These electromagnetic mixing systems are also called PMD systems (photonic mixer device systems) in the abovementioned published documents. The subject of DE 100 47 170 C2 is regarded as the closest state of the art for the present patent application.

A corresponding mixing system has at least one output and at least one modulation input. The modulation input is connected to at least one modulation electrode which is arranged on or embedded in a material sensitive to electromagnetic radiation (generally photosensitive). Furthermore, at least two accumulation electrodes are also allocated to the at least one modulation electrode, one of which can also be identical to a modulation electrode, or if two modulation electrodes are used, both accumulation electrodes can also be identical to the respective modulation electrodes. These accumulation electrodes are connected to readout and evaluation electronics. The charges derived from the accumulation electrodes, or the voltages forming there, form, if appropriate after necessary amplification, the input signals of the output electronics, as a rule the differential signal of the signals derived from the accumulation electrodes being evaluated which reproduces the correlation of the at least one modulation signal with the modulation of the electromagnetic input signal or the impacting electromagnetic radiation.

When several (e.g. two) modulation signals are used, these have the same frequency and, in the case of the known PMD elements, are phase-displaced by 180° vis-à-vis each other, i.e. they run in push-pull manner.

Electromagnetic mixing systems, or PMD elements as they are called below, can be sensitive to radiation from the whole electromagnetic spectrum, depending on the nature of the sensor or sensor material. Even PMD systems sensitive to sound waves are conceivable in principle. However, to simplify the description, reference will essentially be made below to PMD elements which are sensitive to radiation in the optical region without any kind of restriction being intended thereby. Generalization to other regions of the electromagnetic spectrum is obvious for persons skilled in the art.

A photosensitive sensor material (semiconductor material) in which the electrodes are embedded or to which they are connected receives radiation which is converted into [a] charge due to the photo effect. Due to the modulation voltages applied to the modulation electrodes, the charge carriers produced in the semiconductor material are preferably conducted alternately to one or other accumulation electrode, depending on the current sign of the voltage.

If the intensity of the radiation by which the PMD element is impacted varies according to a modulation function which has a coherent relationship with the frequency of the modulation voltages, the differential signal of the readout electrodes corresponds to the correlation function of the incident radiation intensity and the modulation voltages.

In the case of a photosensitive semiconductor, intensity-modulated light is used for example to illuminate a scene which is recorded by the PMD system via a corresponding lens. If the intensity modulation of the illumination correlates with the modulation frequency of the modulation electrodes, the differential output of the PMD element delivers a datum about the transit time of the light from the illumination source over the illuminated scene and back to the PMD sensor. In addition to an image of the illuminated scene, a datum about the distance of the imaged elements of the scene from the PMD element is obtained simultaneously (if a corresponding plurality of PMD elements is connected as pixel array).

Non-coherent light (the term “coherence” always referring here to the frequency of an intensity modulation in relation to the modulation voltages at the modulation inputs of the PMD elements) does not deliver a signal at the differential output of the output electronics. In other words PMD elements automatically eliminate (at their differential output) any non-coherently modulated background illumination.

Moreover, variants are conceivable in which accumulation and modulation electrodes are not necessarily different elements and for example both accumulation electrodes or at least one is identical to both or at least one of the modulation electrodes.

The abovementioned German patent specification DE 100 47 170 describes a method with which an additional phase displacement is produced variably between the intensity-modulated illumination signals in correlation with one another and the modulation signals, this phase displacement being used as correction variable in a closed-loop control circuit in order to in this way improve the accuracy of the measurement of the transit time or distance.

The present invention starts from a PMD system which is constructed essentially of elements similar or identical to those listed at the outset.

If the PMD element is impacted exclusively by radiation which is not in a coherent relationship with the modulation signal, the charges alternately preferably displaced to one and then to the other accumulation electrode by the positive and negative portions or half-waves of the modulation voltages should not differ from one another in the statistical average, with the result that the difference of the voltages integrated at the accumulation electrodes should essentially display the value zero.

However, unavoidable manufacturing tolerances alone result from time to time, in the case of specific PMD elements, in certain asymmetries between the different accumulation electrodes and/or the modulation electrodes. The geometric dimensions and distances between these electrodes can also fluctuate within certain tolerance ranges.

The output signals of a photonic mixer device are produced within the component by mixing an intensity-modulated output signal with a likewise modulated electric signal (modulation voltages). An essential precondition for true results of the mixing process is a high degree of symmetry in the structure of the photonic mixer device. Unbalances in its geometry and in the electric parameter[s] of the two output channels lead to systematic errors in the mixer result (see Buxbaum's dissertation, page 189 ff).

Moreover, in the industrial application of photonic mixer devices, the systematic errors often also depend on the intensity of the photosignal. In this respect, the correction methods known from other detector types which use so-called look-up tables are very time-consuming and scarcely usable for high-speed processes on account of the multidimensionality of the problem posed. This applies in particular when a large number of photonic mixer devices are connected to form a line or array arrangement.

Compared with this state of the art, the object of the present invention is therefore to create a system and a method which also delivers correct mixer results, i.e. measurement signals based exclusively on the coherent radiation, in the case of geometric or electric asymmetries of the PMD elements.

As regards the system, this object is achieved in that apparatuses are provided for independently modifying at least one parameter of one of the modulation voltages in relation to the corresponding parameter of the at least one other modulation voltage.

There can be considered as modifiable parameters of the modulation voltages in this connection for example the relative phase position, the amplitudes of the modulation voltages, the pulse duty ratio and an additionally impressed offset voltage.

As already mentioned, asymmetries in the geometric and/or electric parameters of the PMD elements lead to a corruption of the measurement result and they lead in particular to the differential signal of the integrated PMD accumulation electrodes not vanishing even if the PMD element is not impacted by a radiation which is coherent with a modulation frequency of the modulation electrodes. As likewise already mentioned, in the case of an ideal, symmetrical PMD element, and in the case of symmetrical modulation voltages applied in push-pull manner at the modulation electrodes, the effect of the alternately preferred charge displacement should be neutralized upon integration over a sufficiently long period. However, as already mentioned, this applies only when there is complete symmetry of the PMD element, and moreover naturally also requires a complete symmetry of the modulation voltages running in push-pull manner.

In other words, if the PMD element is not impacted by intensity-modulated radiation, but exclusively by ambient or background radiation, a differential signal different from zero of the outputs of the PMD element can be produced not only by geometric and electric asymmetries of the PMD element itself, but also by an asymmetry of the modulation voltages. Depending on the nature of the asymmetry, the differential signal different from zero can assume positive or negative values.

If, therefore, the asymmetry of the geometric parameters of the PMD element leads to a differential signal different from zero at the output of the PMD element, it should be possible according to the inventors' knowledge to produce the opposite effect through an asymmetry of the modulation voltages, i.e. to correct the asymmetry of the geometric parameters through an asymmetry of the modulation voltages.

The apparatuses according to the invention are therefore suitable and designed to modify the modulation signal(s) such that the output signal which corresponds to the difference of the signals derived from the accumulation electrodes always has the value zero (apart from slight inaccuracies due to incompletely suppressed noises) if the modulations of the received electromagnetic radiation and of the modulation signal(s) are not correlated with one another. Put the other way round, it could be said that the output signal is different from zero if, and only if, the modulations concerned are correlated.

As regards the method, the object forming the basis of the invention is therefore achieved in that the at least one modulation signal is modified in that the output signal assumes a value different from zero only if the at least one modulation signal and the modulated electromagnetic reception signal are correlated with each other.

According to the present invention, there are various possibilities for this. Firstly, when there are two modulation signals, the relative phase position of the modulation voltages, which is exactly 180° in the case of a conventional PMD element, can be varied, whereby a variation of the phase position by up to ±30° relative to one another should in general be sufficient, and according to the invention a maximum phase displacement of 90° of the modulation voltages vis-à-vis one another, in each case starting from a push-pull position, is nevertheless provided.

A further possibility of designing the modulation voltages asymmetrically consists for example of a modification and adaptation of the amplitude ratio. Still another possibility is to modify the pulse duty ratio of one of the modulation voltages in relation to the pulse duty ratio of the other modulation voltage, and finally it is conceivable to also add a constant offset d.c. voltage value to each of the modulation voltages. It should generally suffice if the amplitude ratio and also the pulse duty ratio of the two modulation voltages vary by a factor which lies between approximately 0.3 and 3.

It is understood that it is equally possible to impact only one of the modulation electrode with only a single modulation signal, in particular if it this identical to an accumulation electrode. The potential of this one accumulation electrode is alternately raised or lowered by the modulation signal vis-à-vis another, adjacent or spatially allocated, accumulation electrode, with the result that the charges produced by the electromagnetic radiation in the material concerned likewise alternately preferably flow in the direction of one accumulation electrode or in the direction of the other accumulation electrode, depending on whether the modulated accumulation electrode is situated precisely at a higher or a lower potential. In this case, the necessary parameter modifications consist of a modification of the wave shape or an asymmetry set in a targeted way between positive and negative half-waves.

Essentially, the situation is considered in the following in which both accumulation electrodes are impacted either directly or by additional modulation electrodes by a modulation signal each, the two modulation signals running essentially in push-pull manner. It is understood that the procedure described can be transferred wholly analogously to a single modulation signal which is defined in the same way by specific parameters as the two modulation signals when using two modulation electrodes.

Naturally it is not essential to modify the parameters of the modulation voltages exactly such that the differential signal of the PMD element assumes precisely the value zero (as long as there is no coherent radiation), but it is equally well possible to also produce in targeted manner a specific output value or base value of the output signal or differential signal at the output of the PMD element.

The corresponding apparatuses for modifying the parameters of the modulation voltages are expediently designed such that the different parameter modifications are independent of one another. Both the pulse duty ratio and the amplitude of one modulation voltage could therefore be modified without further ado relative to the other modulation voltage. In addition, the phase position can also be modified or a DC offset voltage impressed. In other words, the parameters can be varied both individually and in any combinations. It is understood that the parameter variations described above can also be carried out analogously with an individual modulation signal, the corresponding parameters then not being relative parameter displacements between two independent modulation signals, but for example the positive and negative half-waves of a modulation signal being asymmetrically developed instead. Similarly to when using two modulation signals, the pulse duty ratio between positive and negative half-waves can then also be varied, likewise the corresponding amplitudes of the half-waves. Both can take place by impression of a DC offset voltage alone. Analogously to the modification of phases, when there is a single modulation signal, rising and falling edges of the modulation signals can be developed asymmetrically relative to one another.

The method according to the invention with a feedback adjusting the output signal to zero is used only if the PMD element is impacted by non-coherent radiation, the term “coherent” always referring to a coherent relationship of the intensity modulation of the radiation to the frequency of the modulation voltages. In this state, as already mentioned, with an ideal PMD system, the differential signal should have the value zero, and the parameters of the modulation voltages are preferably modified if necessary precisely such that the differential output of the PMD system shows the value zero. It is for example also possible, where the PMD element is impacted by coherent radiation, to interrupt this coherent radiation from time to time for a short period of time in order to carry out a readjustment of the parameters of the modulation voltages during this interruption. This expediently takes place with the help of a control loop with which the “no-load signal” which appears at the differential input of the PMD system if this is not impacted by coherent radiation is entered as input variable into a regulator which thereupon modifies the parameters of the modulation voltages such that the no-load value of the differential output is adjusted to zero.

During the actual measurement phases during which the PMD element receives coherent, intensity-modulated radiation, the previously ascertained or adjusted asymmetrical setting of the parameters of the modulation voltages naturally remains unchanged and is modified again, if appropriate, only by the next calibration phase.

In a further, preferred version of the invention, during such calibration phases, there is preferably also a non-coherent, additional radiation impaction of the PMD element with an additional radiation intensity which on average corresponds roughly to the average intensity of the coherent radiation portion during the measurement phases. In this way intensity-dependent fluctuations of the no-load signal are also taken into account by the calibration.

As an alternative to the modification of the parameters of the modulation signal(s), it is also conceivable to vary the electric signals derived from the accumulation electrodes, which are in general relatively weak currents or voltages which are connected to the inputs of output electronics, i.e. to amplify or attenuate them such that they are then the same (and their difference therefore vanishes) precisely when the modulations of the received electromagnetic radiation signal and of the at least one modulation signal are not correlated with each other. This can take place for example in that the mixing system is impacted by not specially modulated electromagnetic radiation, for example by ambient light or any other illumination not modulated in a targeted manner, while simultaneously one or two modulation signals apply at the modulation input or the modulation inputs (in the case of two modulation signals, these two running in push-pull manner relative to each other), the input signals of the output electronics then being compared with one another and at least one of the signals being amplified or attenuated such that it is identical to the other input signal, with the result that the difference of the two signals derived from the accumulation electrodes is equal to zero. This may possibly need to be carried out for different intensities of the electromagnetic radiation if the difference of the two input signals of the output electronics should be intensity-dependent. In this case, the variation of the amplification or attenuation of one of the two signals would also be carried out in intensity-dependent manner. Upon additional impaction by a modulated radiation signal, the attenuation and amplification of one input signal of the output electronics then takes place in the same way as without the impaction by the modulated voltage, one correction at most being carried out because of the consequently changing overall intensity. The correlation of the radiation signal with the modulation signal or the modulation signals then leads to the two input signals, derived from the accumulation electrodes, of the output electronics also being different from each other after the attenuation or amplification as carried out without the modulated irradiation, with the result that the difference of the two signals does not vanish.

Further advantages, features and application possibilities of the present invention become clear with the help of the following description of a preferred version and of the associated figures. There is shown in:

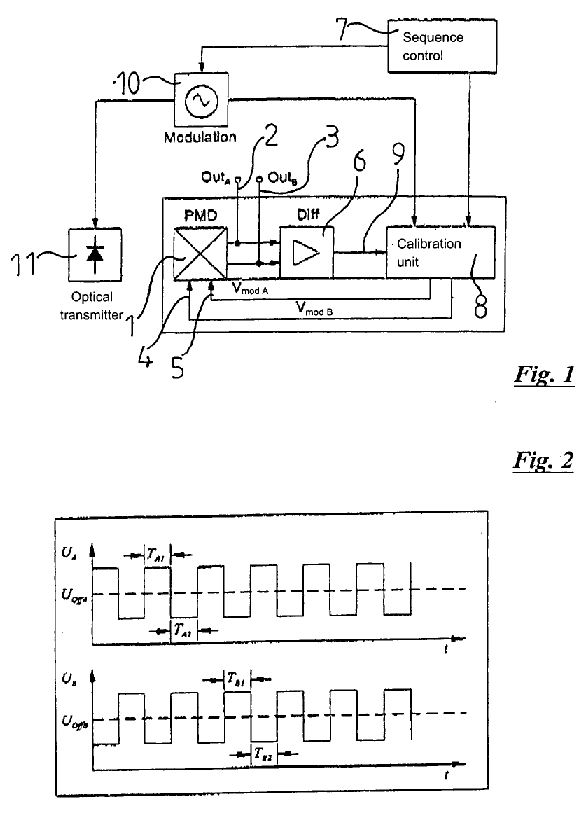

FIG. 1 a block diagram with a calibration unit according to the invention,

FIG. 2 a schematic representation of the modulation signals by which an exactly symmetrical PMD system is impacted,

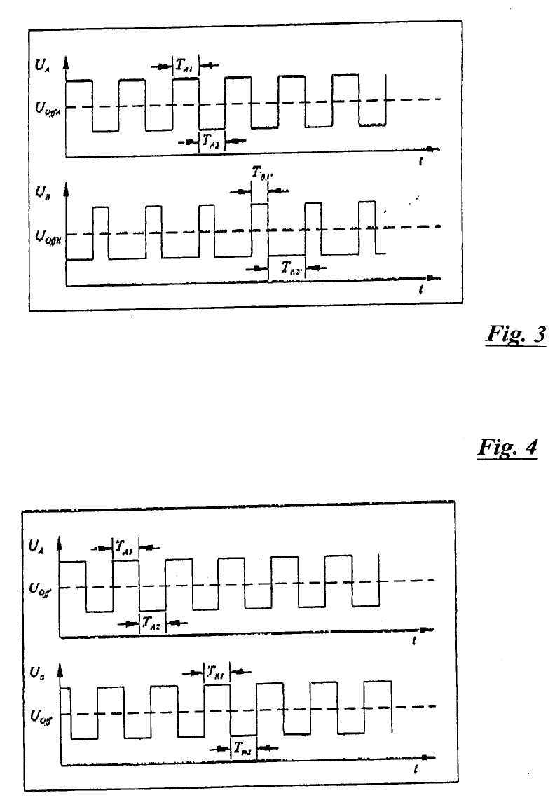

FIG. 3 a variation of the pulse duty ratio of one of the modulation signals in relation to the other modulation signal,

FIG. 4 phase-displaced modulation signals,

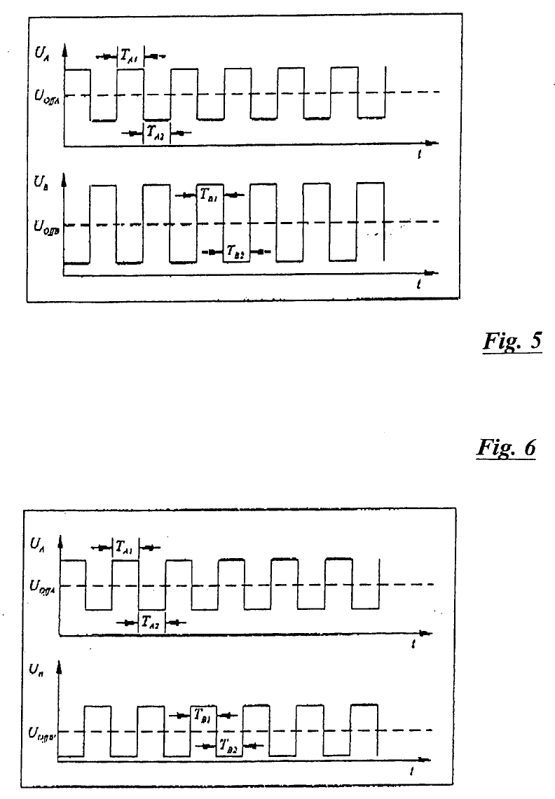

FIG. 5 modulation signals with different amplitudes and

FIG. 6 modulation signals with different offset voltage.

For the following description, there is considered as an embodiment a PMD element which is sensitive to electromagnetic radiations in the visible region. Versions are described in which the mixing system uses two modulation inputs and correspondingly two modulation electrodes and also two modulation signals the parameters of which can be varied independently of each other.

In general the modulation signals are not purely harmonic signals (sine or cosine) but expediently have a more complex wave form in order to be able to better separate and distinguish the modulation signals and the modulation, correlated thereto, of the electromagnetic radiation from ambient signals.

As already mentioned, the parameters of a single modulation signal can also be varied analogously if only a single modulation input is used, for example if accumulation and modulation electrodes or one of the two accumulation electrodes provided pairwise in each case is identical to a modulation electrode.

There can be seen in FIG. 1 an optical transmitter numbered 11 which is modulated by a modulation unit 10 with the result that it emits light with a modulated intensity. In the case of a conventional PMD system, the modulation inputs 4 and 5 of the PMD element 1 are also modulated at the same time by the modulation unit 10, in such a way that the input voltages U_{A} and U_{B} applied at the inputs 4, 5 are phase-displaced precisely in push-pull manner, i.e. by 180° relative to each other, as represented in FIG. 2.

In the present case however, according to the invention a calibration unit 8 is connected between the modulation unit 10 and the modulation inputs 4, 5 of the PMD element 1. In addition, the modulation unit 10 and the calibration unit 8 are controlled by control electronics 7 which control the operating schedule of the whole PMD system.

The voltages or currents tapped at readout electrodes of the PMD element 1 are obtained as signals at the outputs 2, 3, the output electronics 6 expediently being provided in the form of a differential amplifier into which the output signals of the outputs 2, 3 are entered as input variables. The differential signal appears at the output 9 of the output electronics 6 and is entered into the calibration unit 8.

In the case of an ideal, geometrically and electrically symmetrical PMD element the modulation voltages U_{A} and U_{B} are, as represented in FIG. 2, identical apart from a relative phase displacement by 180°. This means that charge produced in the PMD element by impacting radiation of the optical transmitter or of the light reflected by a scene illuminated by the optical transmitter is preferably conducted to one of the outputs 2 or 3 depending on the current sign of the voltages U_{A} and U_{B}. The signals, integrated at the outputs 2 and 3, of the charges produced in this way at accumulation electrodes are subtracted from one another by the differential amplifier 6, a zero signal (hereafter also called “no-load” signal) resulting in the ideal case at the differential amplifier output 9 if the light striking the PMD element is not in correlation in its intensity with the frequency of the modulation voltages 4, 5.

This also applies in particular if the modulation of the optical transmitter 11 is switched off with the result that only ambient or background light strikes the PMD element.

If however the light striking the PMD element is correlated in its intensity with the modulation voltages U_{AQ} or U_{B}, i.e. in particular has the same frequency and is phase-displaced merely on the basis of a certain transit time, a non-vanishing correlation signal is produced at the output of the differential amplifier 6. In this case, the feedback loop (connection to the differential output 9) of the calibration unit is switched off and relays the modulation signal for the modulation inputs 4, 5 with the most recently chosen parameter setting.

If however the individual electrodes of the PMD element 1 are geometrically or electrically arranged and structured in a not completely symmetrical way, a non-vanishing signal 9 will usually be measured at the output of the differential amplifier 6 even if the modulation of the optical transmitter 11 is switched off.

However, the calibration unit according to the invention ensures that such asymmetries which lead to a non-vanishing signal at the output 9 of the differential amplifier 6 can be compensated for although the PMD element is irradiated with light which is not coherent to the modulation frequency. This is finally shown by an example in which the voltages U_{A}, U_{B} are displaced by different offset voltages U_{OFFA} or U_{OFFB} vis-à-vis a virtual mass level.

If the PMD signal is not impacted by modulated light and the output signal 9 at the output of the differential amplifier 6 has a non-vanishing value, the calibration unit uses at least one of the variations shown in FIGS. 3 to 6 of the modulation voltage in order to thereby compensate for the asymmetry of the PMD element such that a zero signal nevertheless appears at the output 9 of the differential amplifier 6. For this, several of the variations represented in FIGS. 3 to 6 can also be carried out simultaneously.

It is particularly expedient if the modulation of the optical transmitter 11 is briefly switched off during an ongoing measurement or reception by the sequence request control in ongoing operation of a PMD system in order to activate the calibration unit 8 during this period and to calibrate the system by suitable variation of the modulation voltages U_{A}, U_{B} at the inputs 4 and 5 respectively of the PMD element.

During the switching off of the modulation of the optical transmitter 11, an additional illumination could however still take place through the optical transmitter 11 by keeping its intensity at a constant average level which also corresponds to the average illumination intensity in the modulation operation of the optical transmitter. In this way, in particular intensity-dependent equilibrium disturbances of the PMD are also taken into account.

The method according to the invention thus allows a calibration of PMD systems in that a signal 9 measured at the output of the differential amplifier 6 always corresponds exactly to the correlation signal, with the result that a very high accuracy can thereby be achieved and the influence of other radiation sources or also the influence of asymmetries can be completely disregarded.

1. Electromagnetic mixing system for receiving and processing modulated electromagnetic signals, with a signal detector made from a semiconductor material for receiving and converting electromagnetic radiation into an electric measured value and with at least one modulation input modulating the reception of the signal detector, and also with at least two accumulation electrodes which are connected to output electronics at the output of which a mixture of the received signal and at least one modulation signal applied at the modulation input is effectively provided as electric signal, characterized in that apparatuses for modifying parameters of the at least one modulation signal are provided such that by modifying these parameters the output signal is different from a zero signal only if the modulations of the received electromagnetic radiation signal and of the at least one modulation signal are correlated with each other.

2. Mixing system according to claim 1, characterized in that the apparatuses (8) are designed to develop the positive or negative half-waves of the modulation signal asymmetrically.

3. Mixing system according to claim 2, characterized in that the apparatuses (8) are designed to develop the positive or negative half-waves of the modulation signal with different amplitudes.

4. Mixing system according to claim 2 or 3, characterized in that the apparatuses (8) are designed to develop the positive or negative half-waves of the modulation signal with a different pulse duty ratio.

5. Mixing according to one system of claims 2-3, characterized in that the apparatuses (8) are designed to overlay a symmetrical modulation signal with a DC voltage value as offset.

6. Mixing system according to one of claims 1 to 3, characterized in that two modulation inputs are provided for two independent modulation signals which have the same modulation frequency, but differently settable absolute and/or relative setting parameters.

7. Mixing system according to claim 6, characterized in that the settable parameters comprise the amplitudes, the phase position, the pulse duty ratios and any offset voltages of the modulation signals.

8. Mixing system according to claim 6, characterized in that the apparatuses (8) are designed to displace the relative phase position of the modulation voltages, starting from a push-pull position, by up to a maximum of ±90°.

9. Mixing system according to claim 6, characterized in that the variation of the ratio of the amplitude modulation voltages or of the pulse duty ratio is essentially limited to a range of a factor of approximately 0.3 to approximately 3.

10. Mixing system according to one of claims 1 to 3, characterized in that the apparatuses (8) are designed such that the modifications of the various parameters are independent of one another.

11. Method for operating an electromagnetic mixing system for receiving and processing modulated electromagnetic signals, with a signal detector made from a semiconductor material for receiving and converting electromagnetic radiation into an electric measured value, and with at least one modulation input modulating the reception of the signal detector and also at least two accumulation electrodes which are connected to output electronics at the output of which a mixture of the received signal and at least one modulation signal applied at the modulation input is effectively provided as electric signal, the electromagnetic signals striking the signal detector producing charge carriers which, depending on the at least one modulation signal, are conducted at least partially alternately to the at least two different readout electrodes, characterized in that the at least one modulation signal is varied such that the output signal assumes a value different from zero only if the at least one modulation signal and the modulated electromagnetic reception signal are correlated with each other.

12. Method according to claim 11, characterized in that the variable parameter of the at least one modulation voltage is selected from the group which consists, of:
a) the pulse duty ratio of the positive and negative half-waves,
b) the amplitude of the positive and negative half-waves,
c) an impressed DC offset voltage.

13. Method according to one of claims 11 or 12, characterized in that the output signal of the mixing is fed to system a calibration unit (8) which in a calibration operation modifies at least one of the parameters of at least one modulation voltage such that the value of the output signal assumes a no-load level if the mixing system is irradiated by an electromagnetic radiation the intensity variation of which does not correlate with the at least one modulation voltage.

14. Method according to claim 13, characterized in that the no-load value corresponds to zero voltage or current value of the output signal.

15. Method for operating a mixing system according to one of claims 11 to 12, characterized in that, when using at least two modulation signals, the relative values of at least one of the parameters of the modulation signals are varied.

16. Method according to claim 15, characterized in that the parameter of one of the modulation voltages which is modified in relation to the corresponding parameter of the other modulation voltage is at least one of the parameters which are selected from the group which consists of:
a) the pulse duty ratio,
b) the relative phase position of the two modulation voltages,
c) the relative amplitude of the two modulation voltages and
d) offset voltage impressed on one or both modulation voltages.

17. Electromagnetic mixing system for receiving and processing modulated electromagnetic signals, with a signal detector made from a semiconductor material for receiving and converting electromagnetic radiation into an electric measured value and with at least one modulation input modulating the reception of the signal detector, and also with at least two accumulation electrodes which are connected to output electronics at the output of which a mixture of the received signal and at least one modulation signal applied at the modulation input is effectively provided as electric signal, characterized in that apparatuses for influencing the signals derived from the accumulation electrodes are provided which influence these signals such that the output signal is reduced to a zero signal whenever the modulations of the received electromagnetic radiation signal and the at least one modulation signal are not correlated with each other.

18. Method for operating an electromagnetic mixing system for receiving and processing modulated electromagnetic signals, with a signal detector made from a semiconductor material for receiving and converting electromagnetic radiation into an electric measured value, and with at least one modulation input modulating the reception of the signal detector and also at least two accumulation electrodes which are connected to output electronics at the output of which a mixture of the received signal and at least one modulation signal applied at the modulation input is effectively provided as electric signal, the electromagnetic signals striking the signal detector producing charge carriers which, depending on the at least one modulation signal, are conducted at least partially alternately to the at least two different readout electrodes, characterized in that the signals derived from the accumulation electrodes and entered by the output electronics are varied such that the output signal assumes a value different from zero only if the at least one modulation signal and the modulated electromagnetic reception signal are correlated with each other.
